(19) United States
(12) Patent Application Publication
(10) Pub. No.: US 2022/0175131 A1
(43) Pub. Date: Jun. 9, 2022

(54) METHODS AND APPARATUS TO ANALYZE DESK HEIGHTS

(71) Applicant: Intel Corporation, Santa Clara, CA (US)

(72) Inventors: Guoqing Zhang, Tampere (ES); Bennett Ng, San Francisco, CA (US)

(21) Appl. No.: 17/671,234

(22) Filed: Feb. 14, 2022

(51) Int. Cl. A47B 13/00; G01S 17/08; G01C 9/02; A47B 9/04

(52) U.S. Cl. CPC A47B 13/00; G01S 17/08; G01C 9/02; A47B 2200/0051; A47B 2200/0021; A47B 2200/0062; A47B 9/04

(57) ABSTRACT

Methods and apparatus to analyze desk heights are disclosed. A disclosed example apparatus includes a distance sensor to measure a distance from a computing device on a table surface to a floor surface, an orientation sensor to measure an orientation of the distance sensor relative to a direction of gravity, at least one memory, instructions, and processor circuitry to execute the instructions to calculate at least one of a first height of the table surface from the floor surface or a second height of at least a portion of the computing device to the floor surface based on the orientation and the distance.

### FIELD OF THE DISCLOSURE

This disclosure relates generally to ergonomic height analysis and, more particularly, to methods and apparatus to analyze desk heights.

### BACKGROUND

In known implementations, a height of an ergonomic table, such as a motorized standing desk, is currently measured and tracked by the table via motor encoders. These known implementations can have some drawbacks, however. Particularly, without ongoing and/or periodic calibration, a table height measurement may be inaccurate and/or susceptible to drift over time. Further, height information/data remains in memory of the table and is typically not accessible by other systems without manual input from a user.

### BRIEF DESCRIPTION OF THE DRAWINGS

FIG. 1 is an overview of an example height analysis implementation in accordance with teachings of this disclosure.

FIG. 2 is a block diagram of an example height analysis system that can be implemented in examples disclosed herein.

FIG. 3 depicts an example image analysis that can be implemented in examples disclosed herein.

FIGS. 4 and 5 are flowcharts representative of example machine readable instructions and/or example operations that may be executed by example processor circuitry to implement the example height analysis system of FIG. 2.

FIG. 6 is a block diagram of an example processing platform including processor circuitry structured to execute the example machine readable instructions and/or the example operations of FIGS. 4 and 5 to implement the example height analysis system of FIG. 2.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 4 and 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

In known implementations, a height of an ergonomic table, such as a motorized standing desk, is currently measured and tracked by the table via motor encoders. These known implementations can have some drawbacks, however. Particularly, without ongoing and/or periodic calibration, a table height measurement may be inaccurate and/or susceptible to drift over time. Further, height information/data remains in memory of the table and is typically not accessible by other systems without input from a user, thereby requiring manual adjustment by the user.

Examples disclosed herein enable accurate determination of height of a surface (e.g., a desk surface, a table surface, an ergonomic height, etc.) or other feature and/or geometric aspect of a desk. Examples disclosed herein can be implemented to accurately control a height of a table surface of the desk so that desired or preferred ergonometric settings can be set for a user of the desk. Examples disclosed herein can enable an ergonomic desk to automatically adjust to a user without manual input therefrom. Examples disclosed herein can also be implemented to maintain a height of a desk, thereby mitigating the effects of drift, etc.

Examples disclosed herein utilize a first sensor to measure a distance from a computing device on a table surface to a point on and/or area of a floor surface. Further, a second sensor is to measure an orientation of the first sensor relative to a direction of gravity and/or a gravitational force vector. In turn, processor circuitry is to execute instructions to determine a height of the computing device and/or the table surface based on the distance and the orientation.

In some examples, the processor circuitry is to execute the instructions to determine an angle of at least a portion of the computing device, such as a display portion (e.g., a display of laptop computer). In some examples, the processor circuitry is to execute the instructions to calculate the height of the table surface based on the height and a distance from the table surface to the aforementioned at least a portion of the computing device. In some examples, the processor circuitry is to execute the instructions to generate a kinematic model for determination of the height of the table surface. In some examples, an actuator is to control a height of the desk and a controller is to direct movement of the actuator based on at least one of the height of the table surface, a height of the computing device from the table surface, or biometric data. In some examples, an image sensor is implemented for orienting the first sensor toward the floor surface (e.g., a point and/or area of the floor surface). In particular, the first sensor can be oriented and/or directed toward a landmark or point of a room and/or area.

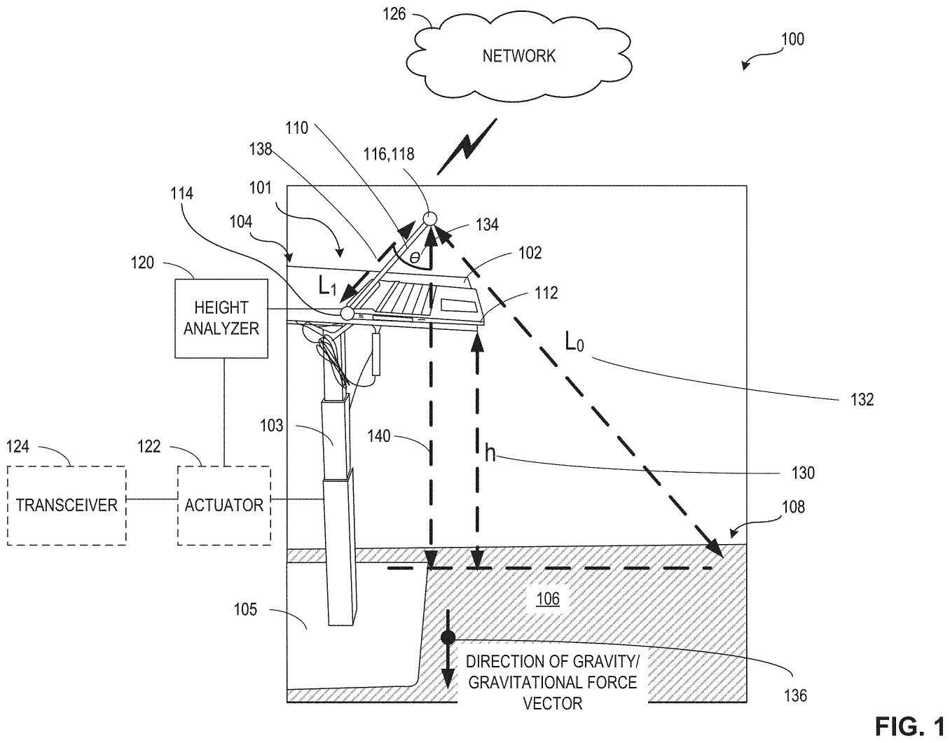

FIG. 1 is an overview of an example height analysis implementation 100 in accordance with teachings of this disclosure. In this example, a computing device 101 is depicted as being positioned on and/or supported by a table surface 102 of a desk (or table) 104, which is implemented as a height adjustable desk in this example. In the illustrated example of FIG. 1, the desk 104 is positioned above a floor surface (e.g., a ground surface, a flooring, etc.) 106 of a floor 108. and includes an extendible support 103 and a base 105.

The example computing device 101 is implemented as a computer (e.g., a laptop computer, a tablet computer, a mobile phone, etc.) having a screen (e.g., a screen portion, a foldable screen, a display portion, a folding display portion, etc.) 110 and base/keyboard portion 112 such that the screen 110 is rotatable relative to the base/keyboard portion about a hinge 114. In this example, the computing device 101, hardware on or proximate the desk 104 and/or the desk 104 includes a distance sensor 116, which is implemented as a light detection and ranging (LiDAR) sensor in this example. However, any other type of distance sensor can be implemented instead. In this example, the computing device 101, hardware on or proximate the desk 104 and/or the desk 104 includes an orientation sensor 118, which is implemented as an inertial measurement unit (IMU) sensor in this example. However, any other orientation/direction sensor can, instead, be implemented.

In the illustrated example of FIG. 1, a height analyzer 120 can be implemented in and/or associated with (e.g., communicatively coupled to) the computing device 101. Further, an actuator 122 is controlled to adjust a height at which the desk 104 and/or the table surface 102 are positioned relative to the floor surface 106. Additionally or alternatively, a transceiver 124 is implemented to facilitate communication between the desk 104, the computing device 101 and/or the height analyzer 120 with the computing device 101. In other words, the computing device 101 can control and/or determine a height of the desk 104. Additionally or alternatively, the example of FIG. 1 is communicatively coupled to and/or includes a network 126. However, any appropriate data and/or network topology can be implemented instead.

In operation, the height analyzer 120 is implemented to determine a height 130, which is denoted as “h” in FIG. 1, based on a distance 132 denoted as “L₀,” as well as an angle 134 denoted by “⊖” that is related to a direction of gravity (e.g., a gravitational force vector) 136. Additionally or alternatively, the height 130 can be calculated based on at least one of a length 138 of the screen 110 or a height 140 of a portion (e.g., an upper portion) of the screen 110, the distance sensor 116 and/or the orientation sensor 118. An example calculation of the height 130 is shown in Equation 1 below:

h=L₀sinθ−L₁cosθ (1),

where the aforementioned parameter, L₀, is the distance 132 measured by/from the distance sensor 116, which can be implemented as a LiDAR sensor, to the floor surface 106, and L₁ is the length 138 from the sensor 116 to the surface 102 of the table 102. The length 138 (L₁) can be a known or assumed value, for example, and, as a result, the height 130 (h) is calculated with Equation 1 above. In this example, the angle 134 (θ) is the only unknown in the above equation and can be estimated, measured and/or calculated using data from the orientation sensor 118, which can be implemented as an accelerometer in some examples. In some examples, the reading of the sensor 118 can be approximately 9.8 meters per second squared (m/s²) when the angle 134 (θ) is zero or approximately zero. In some examples, the angle 134 (θ) is an unknown that is calculated via Equation 1 (while the height 130 is known). However, the value of the angle 134 (θ) can be estimated using the accelerometer of the orientation sensor 118, which is implemented as an IMU sensor, for example. In some examples, to mitigate noise from readings (e.g., IMU readings) associated with the orientation sensor 118, a sampling window can be employed to calculate an average thereof for improved estimation of a value of the angle 134 (θ). In some examples, a relatively high update frequency of the orientation sensor 118 will reduce any noticeable delay in data acquisition from the orientation sensor 118.

Normally, a LiDAR sensor can have a reduced update frequency in comparison to an IMU sensor. Accordingly, in some examples, a an Extended Kalman Filter (EKF) kinematic model, which can be relatively loosely coupled, is implemented to advantageously provide real-time tracking capabilities. By implementing the EKF, acceleration information from the IMU sensor can be utilized to estimate a height of the desk 104 using a kinematic model, and the actual height derived from the low-frequency LiDAR data can be used for correction. The covariance propagation in the EKF can provide information on estimation certainty, for example.

In some examples, the determined height of the table surface 102 and/or an overall height of the computing device 101 is utilized for control (e.g., automated control) of the height of the desk 104. In some such examples, the height of the desk 104 is adjusted based on a user and/or a user profile (e.g., a biometric user profile) of the user. In some examples, the height analyzer 120 is unitary with and/or part of the computing device 101. In some examples, a biometric profile and/or biometric data of a user is retrieved and/or received from the network 126. In some examples, the distance sensor 116 and the orientation sensor 118 are unitary.

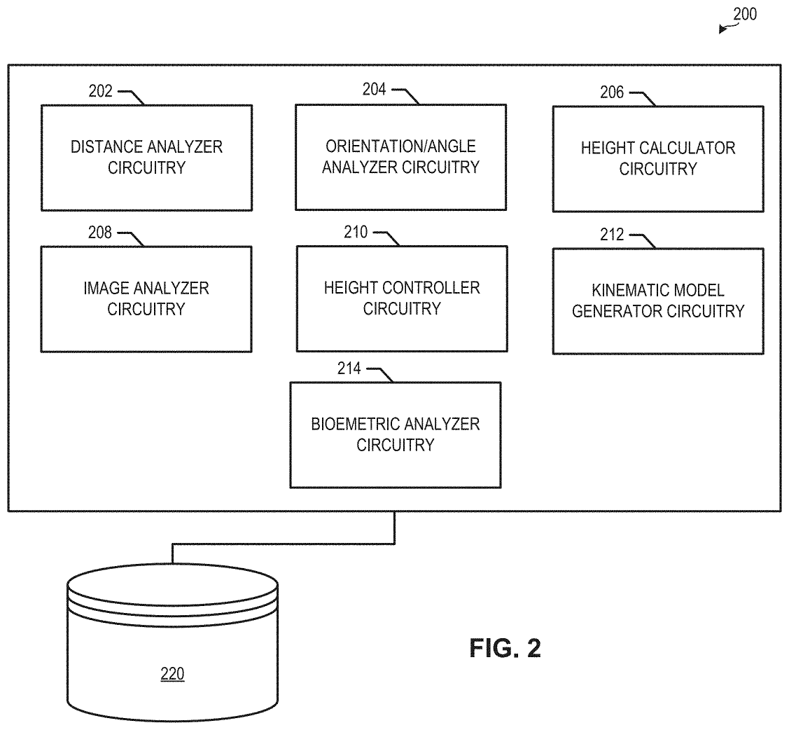

FIG. 2 is a block diagram of an example height analysis system 200 to analyze and/or determine height information of the computing device 101 and/or the table surface 102 on which the computing device 101 is supported and/or positioned. The example height analysis system 200 can be implemented in the height analyzer 120, the desk 104 and/or the computing device 101 shown in FIG. 1. The example height analysis system 200 of FIG. 2 may be instantiated (e.g., creating an instance of, bring into being for any length of time, materialize, implement, etc.) by processor circuitry such as a central processing unit executing instructions. Additionally or alternatively, the height analysis system 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

The example height analysis system 200 includes example distance analyzer circuitry 202, example orientation/angle circuitry 204, example height calculator circuitry 206, example image analyzer circuitry 208, example height controller circuitry 210, and example kinematic model generator circuitry 212. In some examples, the height analysis system 200 includes biometric analyzer circuitry 214. In some examples, a data storage 220 is implemented to store data, such as ergonomic/biometric data, kinematic data, etc.

The distance analyzer circuitry 202 of the illustrated example is implemented to determine and/or calculate a distance based on information and/or sensor output from the distance sensor 116. In the illustrated example, the distance is measured from the distance sensor 116 to a point and/or feature of the floor surface 106 to which the distance sensor 116 is aimed, oriented and/or directed.

The example orientation/angle circuitry 204 determines an orientation of the distance sensor 116, the screen 110 and/or the computing device 101 relative to gravity and/or the floor surface 106. In this example, the orientation is determined based on information from an IMU sensor. Additionally or alternatively, another type of gravitational direction sensor is implemented to determine an orientation of the distance sensor 116 relative to gravity and/or a gravity vector.

In this example, the height calculator circuitry 206 calculates a height of the desk 104 and/or the table surface 102 based on the aforementioned distance and orientation. According to examples, disclosed herein, a calculation such as Equation (1) described above is utilized to calculate the height of the table surface 102 and/or the computing device 101. However, any other geometric and/or kinematic calculation can be implemented instead.

In some examples, the image analyzer circuitry 208 is utilized to analyze images from an image sensor associated and/or unitary with the distance sensor 116. In some such examples, the image analyzer circuitry 208 is utilized to aid and/or facilitate in orienting (e.g., aiming) the distance sensor 116 and/or the screen 110 (that orients the distance sensor 116) toward a portion (e.g., a designated portion or region) of the floor surface 106. Particularly, the image analyzer circuitry 208 can be utilized to guide a user to aim the distance sensor 116 toward a designated region, area and/or point of the floor surface 106 via an image shown on the screen 110, for example.

In some examples, the height controller circuitry 210 is implemented to control a height of the desk 104 and/or the table surface 102. In some such examples, the height of the desk 104 and/or the table surface 102 can be controlled by directing the actuator 122 to move the table surface 102 and/or a portion of the desk 104.

According to some examples disclosed herein, the kinematic model generator circuitry 212 generates and/or calculates parameters for a kinematic model associated with movement of the desk 104, for example. As mentioned above in connection with FIG. 1, an EKF kinematic model for relatively continuous height estimation and tracking can be implemented.

In some examples, the biometric analyzer circuitry 212 is implemented to determine and/or calculate biometric data of a user utilizing the desk 104. For example, the biometric analyzer circuitry 212 can determine biometric data of the user including, but not limited to, a standing height of the user, a viewing angle of the user, a sitting height of the user, a viewing distance of the user, etc. In some such examples, the aforementioned height controller circuitry 210 utilizes desired biometric parameters (e.g., a desired ergonomic height, a desired viewing angle, etc.) to direct movement of the actuator 122 to control of a height of the table surface 102 and/or the desk 104 in conjunction with the example height controller circuitry 210.

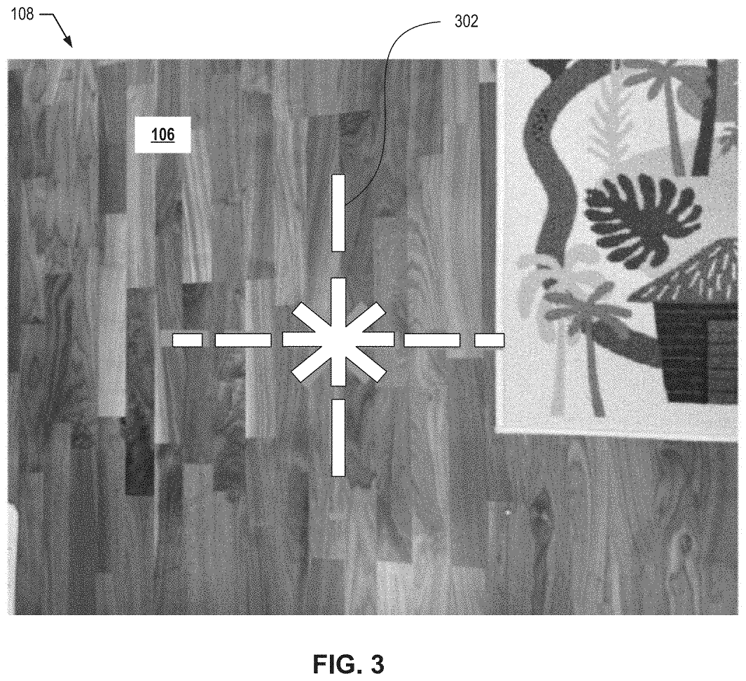

FIG. 3 depicts an example image analysis that can be implemented in examples disclosed herein. In some such examples, a user is guided to orient the distance sensor 116 shown in FIG. 1 so that the sensor 116 is properly oriented and/or positioned toward a point or area of the floor surface 106 of the floor 108. To this end, the user can be presented with an RGB video stream (e.g., via the screen 110) with an over-laid marker or reticle 302, such as shown in FIG. 3. In turn, the marker or reticle 302 can be utilized to ensure that the sensor 116 has adequate visibility to a sufficient portion of the floor 108.

In the illustrated example of FIG. 3, the center of the marker or reticle 302 is located at the pixel that corresponds to the measuring direction of the sensor 116, which is implemented as a LiDAR sensor, for example. The user is prompted to adjust the angle of the display so that an entirety of the marker or reticle 302 is located on the floor surface 106 in the aforementioned video stream. In this example, the information and/or reading(s) from the sensor 116 correspond to the distance from the sensor 116 to the ground along varied heights of the desk 104. Some margin in the marker or reticle 302 can be reserved for shifts when raising or lowering the desk 104, for example. In other words, by ensuring that the marker or reticle 302 fills a significant portion of the RGB stream, the sensor 116 can continue to measure the floor 106 even when the desk 104 is moved up and down relative to gravity.

While an example manner of implementing the height analysis system 200 of FIG. 2 is illustrated in FIG. 2, one or more of the elements, processes, and/or devices illustrated in FIG. 2 may be combined, divided, re-arranged, omitted, eliminated, and/or implemented in any other way. Further, the example distance analyzer circuitry 202, the example orientation/angle analyzer circuitry 204, the example height calculator circuitry 206, the example image analyzer circuitry 208, the example height controller circuitry 210, the example kinematic model generator circuitry 212, the example biometric analyzer circuitry 214, and/or, more generally, the example height analysis system 200 of FIG. 2, may be implemented by hardware alone or by hardware in combination with software and/or firmware. Thus, for example, any of the example distance analyzer circuitry 202, the example orientation/angle analyzer circuitry 204, the example height calculator circuitry 206, the example image analyzer circuitry 208, the example height controller circuitry 210, the example kinematic model generator circuitry 212, the example biometric analyzer circuitry 214, and/or, more generally, the example height analysis system 200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example height analysis system 200 of FIG. 2 may include one or more elements, processes, and/or devices in addition to, or instead of, those illustrated in FIG. 2, and/or may include more than one of any or all of the illustrated elements, processes and devices.

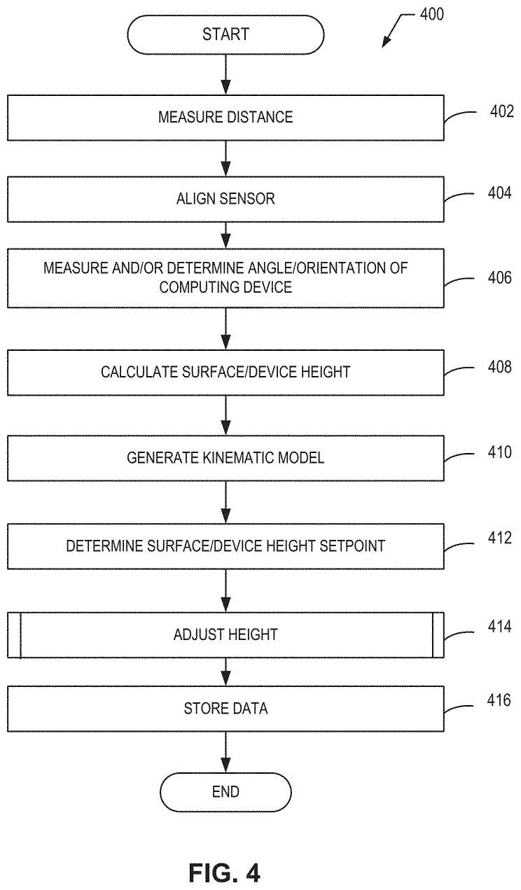

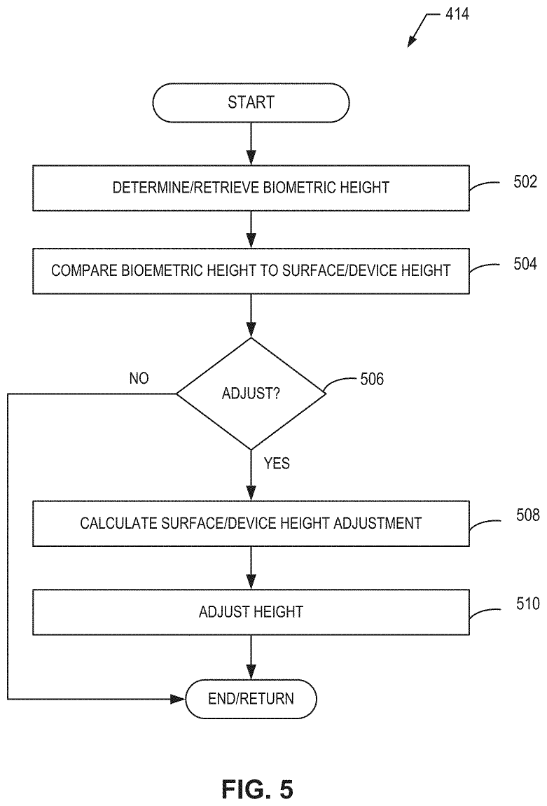

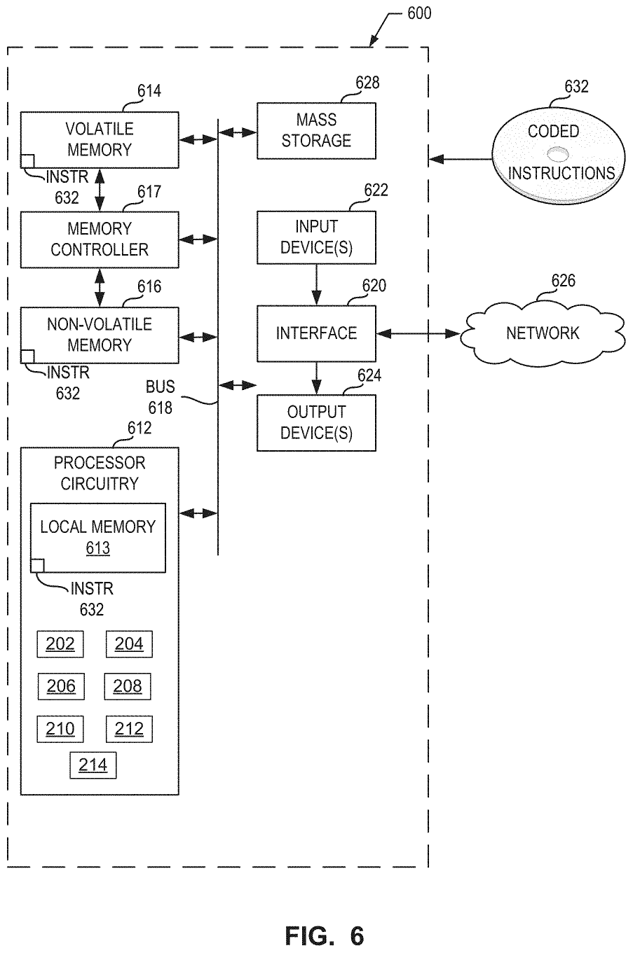

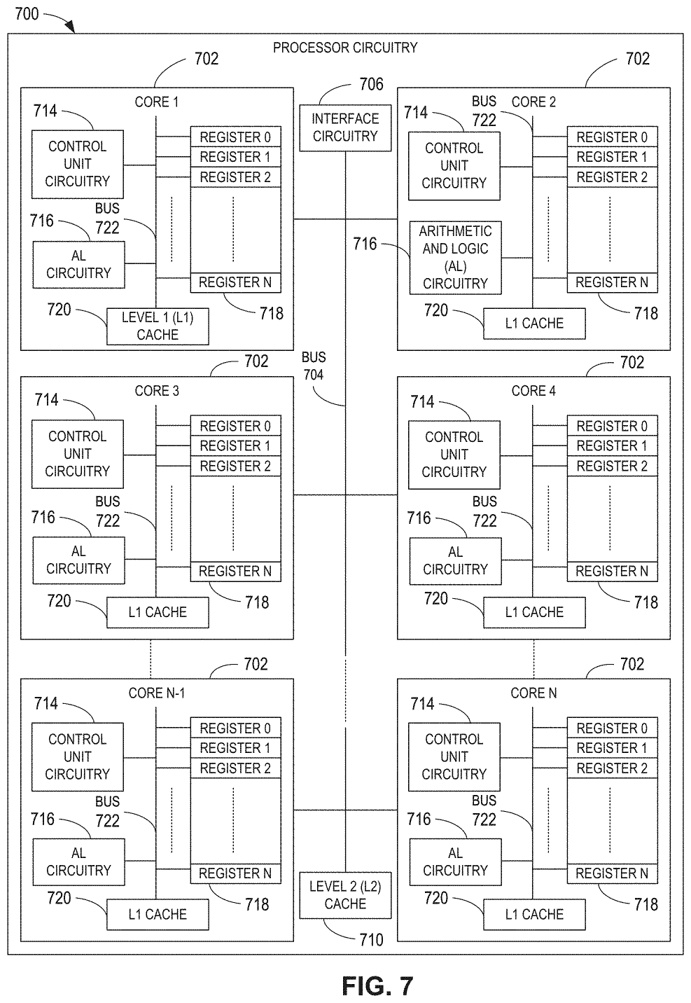

Flowcharts representative of example hardware logic circuitry, machine readable instructions, hardware implemented state machines, and/or any combination thereof for implementing the height analysis system 200 of FIG. 2 are shown in FIGS. 4 and 5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4 and 5, many other methods of implementing the example height analysis system 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to determine and/or control a height of the table surface 102 of the desk 104. The machine readable instructions and/or the operations 400 of FIG. 4 begin at block 402, at which the example distance analyzer circuitry 202 measures and/or determines a distance from the distance sensor 116 of the computing device 101 to the floor surface 106.

At block 404, in some examples, the example image analyzer circuitry 208 is utilized to align the distance sensor 116. As described above in connection with FIG. 3, an image sensor and a reference point of a room, object and/or the floor 108 can be utilized to align and/or orient the distance sensor 116. In some examples, the distance sensor 116 is aligned so that it is facing toward a portion of the floor surface 106 across a full (or relatively close to full) range of vertical motion of the desk 104.

At block 406, the orientation/angle analyzer circuitry 204 of the illustrated example measures an angle and/or orientation of the computing device 101 and/or a component thereof with data from the orientation sensor 118. In this example, the angle and/or orientation associated with the sensor 116 is utilized for determination of a height associated with the desk surface 102 and/or the desk 104. Additionally or alternatively, a distance associated with the computing device 101 (e.g., a length of the screen 110, etc.) is also determined and/or accessed.

At block 408, the example height calculator circuitry 208 calculates a height of a surface and/or a device, such as the computing device 101. In the illustrated example, the height calculator circuitry 208 calculates the height based on the measured angle of the distance sensor 116, the orientation sensor 118 and/or the computing device 101 and the distance to a floor surface 106, for example. As mentioned above, a calculation such as Equation (1) can be performed to calculate the height. In some examples, a distance associated with a portion of the computing device, such as a distance from the table surface 106 to a portion of the computing device 101 and/or the sensor 116, for example, is utilized to calculate the height.

At block 410, in some examples, the example kinematic model generator circuitry 212 generates a kinematic model. In some such examples, the kinematic model is generated to relate measurements/information from the sensor 116 to height(s) of the desk surface 102 and/or the desk 104.

At block 412, in some examples, the example height controller circuitry 210 and/or the example biometric analyzer circuitry 214 determines a setpoint for the aforementioned height of the surface and/or the device, for example. Additionally or alternatively, the setpoint is received from the network 126 via the transceiver 124, for example. In particular, the setpoint can correspond to a user profile stored on the network 126.

In some examples, at block 414, the example height controller circuitry 210 and/or the example biometric analyzer circuitry 214 adjusts the height of the desk 104, the table surface 102 and/or the computing device 101, as will be discussed in greater detail below in connection with FIG. 5.

At block 416, the example height controller circuitry 210 stores data corresponding to the height of the desk 104, the table surface 102 and/or the computing device 101 in the data storage 220 and the process ends.

FIG. 5 is a flowchart representative of an example subroutine 412 of the example machine readable instructions and/or example operations 400 of FIG. 4.

At block 502, the biometric analyzer circuitry 214 of the illustrated example determines and/or retrieves biometric data (e.g., a height) of a user (e.g., a measured height of a user). For example, the biometric analyzer circuitry 214 can utilize biometric data associated with a user to determine the height setpoint. In some examples, the biometric data is received from the network 126 via the transceiver 124.

At block 504, the example biometric analyzer circuitry 214 compares the biometric height to the aforementioned height setpoint.

At block 506, it is determined whether to adjust the height of the desk by the example height controller circuitry 210. If the height is to be adjusted (block 506), control of the process proceeds to block 508. Otherwise, the process ends/returns.

At block 508, the example height controller circuitry 210 calculates and/or determines a height adjustment of the desk 104. The height adjustment can be based on the biometric data and/or the aforementioned setpoint.

At block 510, the height controller circuitry 210 directs movement of the actuator 122, for example, to adjust the height of the desk 104 and/or the desk surface 102 and the process ends/returns.

FIG. 6 is a block diagram of an example processor platform 600 structured to execute and/or instantiate the machine readable instructions and/or the operations of FIGS. 4 and 5 to implement the height analysis system 200 of FIG. 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example distance analyzer circuitry 202, the example orientation/angle analyzer circuitry 204, the example height calculator circuitry 206, the example image analyzer circuitry 208, the example height controller circuitry 210, the example kinematic model generator circuitry 212, and the example biometric analyzer circuitry 214.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 632, which may be implemented by the machine readable instructions of FIGS. 4 and 5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a general purpose microprocessor 700. The general purpose microprocessor circuitry 700 executes some or all of the machine readable instructions of the flowcharts of FIGS. 4 and 5 to effectively instantiate the circuitry of FIG. 2 as logic circuits to perform the operations corresponding to those machine readable instructions. In some such examples, the circuitry of FIG. 2 is instantiated by the hardware circuits of the microprocessor 700 in combination with the instructions. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and 5.

The cores 702 may communicate by a first example bus 704. In some examples, the first bus 704 may implement a communication bus to effectuate communication associated with one(s) of the cores 702. For example, the first bus 704 may implement at least one of an Inter-Integrated Circuit (I2C) bus, a Serial Peripheral Interface (SPI) bus, a PCI bus, or a PCIe bus. Additionally or alternatively, the first bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may implement at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

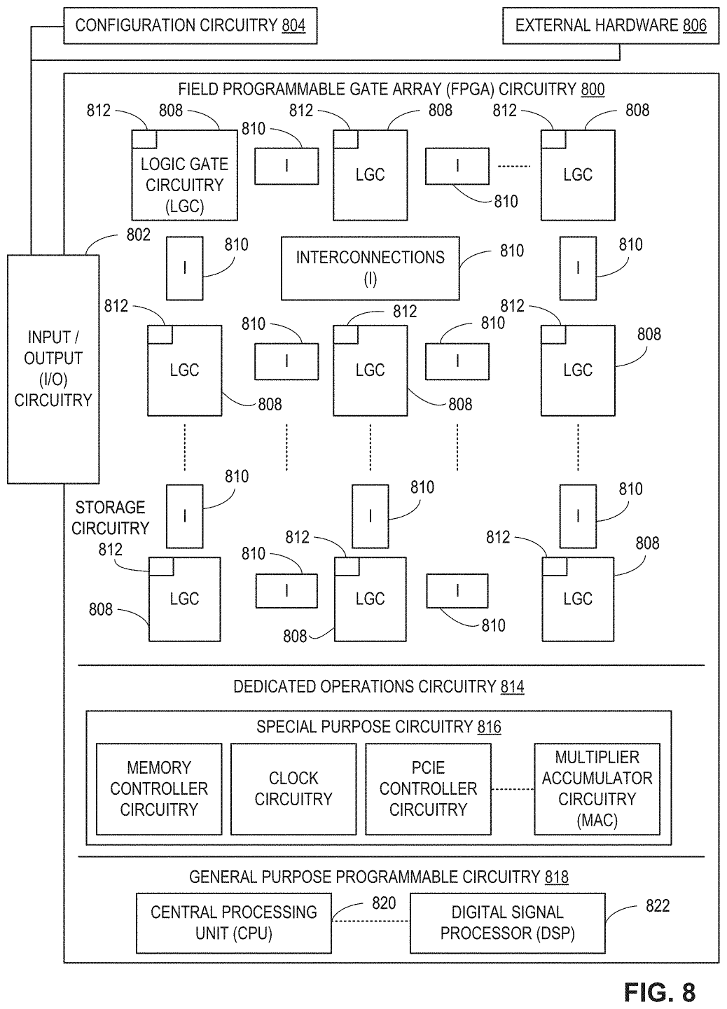

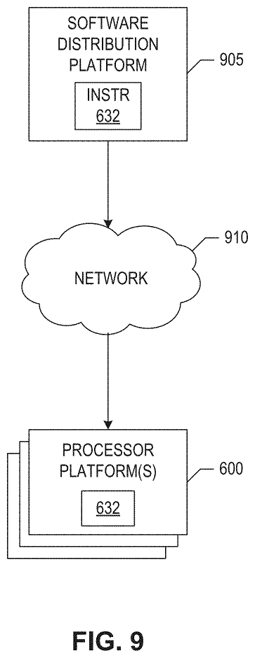

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 4 and 5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIGS. 4 and 5. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 4 and 5. As such, the FPGA circuitry 800 may be structured to effectively instantiate some or all of the machine readable instructions of the flowcharts of FIGS. 4 and 5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 4 and 5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIGS. 4 and 5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowchart of FIGS. 4 and 5 may be executed by one or more of the cores 702 of FIG. 7, a second portion of the machine readable instructions represented by the flowcharts of FIGS. 4 and 5 may be executed by the FPGA circuitry 800 of FIG. 8, and/or a third portion of the machine readable instructions represented by the flowcharts of FIGS. 4 and 5 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 612 of FIG. 6 may be in one or more packages. For example, the processor circuitry 700 of FIG. 7 and/or the FPGA circuitry 600 of FIG. 6 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

A block diagram illustrating an example software distribution platform 905 to distribute software such as the example machine readable instructions 632 of FIG. 6 to hardware devices owned and/or operated by third parties is illustrated in FIG. 6. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions 400, 414 of FIGS. 4 and 5, as described above. The one or more servers of the example software distribution platform 905 are in communication with a network 910, which may correspond to any one or more of the Internet and/or the example network 126 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions 400, 414 of FIGS. 4 and 5, may be downloaded to the example processor platform 600, which is to execute the machine readable instructions 632 to implement the example height analysis system 200. In some example, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

Example methods, apparatus, systems, and articles of manufacture to analyze and/or control desk/table heights are disclosed herein. Further examples and combinations thereof include the following: Example 1 includes an apparatus comprising a distance sensor to measure a distance from a table surface to a floor surface, an orientation sensor to measure an orientation of the distance sensor relative to a direction of gravity, at least one memory, instructions, and processor circuitry to execute the instructions to calculate at least one of a first height of the table surface from the floor surface or a second height of at least a portion of a computing device on the table surface to the floor surface based on the orientation and the distance.

Example 2 includes the apparatus as defined in example 1, wherein the processor circuitry is to execute the instructions to determine an angle of at least a portion of the computing device relative to the floor surface.

Example 3 includes the apparatus as defined in example 2, wherein the processor circuitry is to execute the instructions to calculate the first height based on the angle and a distance from the table surface to the computing device.

Example 4 includes the apparatus as defined in any of examples 1 to 3, wherein the processor circuitry is to execute the instructions to generate a kinematic model to calculate the at least one of the first height or the second height.

Example 5 includes the apparatus as defined in any of examples 1 to 4, further including an actuator to change a height of a desk having the table surface, and a controller to direct movement of the actuator based on at least one of the first height, the second height, or biometric data.

Example 6 includes the apparatus as defined in example 5, wherein the controller is unitary with the computing device.

Example 7 includes the apparatus as defined in any of examples 1 to 6, further including an image sensor operatively coupled to the distance sensor, the image sensor for guiding an adjustment of the orientation of the distance sensor toward the floor surface.

Example 8 includes the apparatus as defined in any of examples 1 to 7, wherein the distance sensor is a light detection and ranging (LiDAR) sensor and the orientation sensor is an inertial measurement unit (IMU) sensor.

Example 9 includes a non-transitory computer readable medium comprising instructions, which when executed, cause processor circuitry to determine a distance from a table surface to a floor surface based on information from a distance sensor, determine an orientation of the distance sensor relative to a direction of gravity based on information from an orientation sensor, and calculate at least one of a first height of the table surface from the floor surface or a second height of at least a portion of a computing device on the table surface to the floor surface based on the orientation and the distance.

Example 10 includes the non-transitory computer readable medium as defined in example 9, wherein the instructions cause the processor circuitry to determine an angle of at least a portion of the computing device relative to the floor surface.

Example 11 includes the non-transitory computer readable medium as defined in example 10, wherein the instructions cause the processor circuitry to calculate the first height based on the angle and a distance from the table surface to the computing device.

Example 12 includes the non-transitory computer readable medium as defined in any of examples 9 to 11, wherein the instructions cause the processor circuitry to execute the instructions to generate a kinematic model to calculate the at least one of the first height or the second height.

Example 13 includes the non-transitory computer readable medium as defined in any of examples 9 to 12, wherein the instructions cause the processor circuitry to cause an actuator to change a height of a desk having the table surface based on at least one of the first height, the second height, or biometric data associated with a user of the desk.

Example 14 includes the non-transitory computer readable medium as defined in any of examples 9 to 13, wherein the instructions cause the processor circuitry to cause an image from an image sensor to be displayed on a display to guide an adjustment of the orientation of the distance sensor toward the floor surface.

Example 15 includes a method comprising determining, via a distance sensor, a distance from a table surface to a floor surface, determining, via an orientation sensor, an orientation of the distance sensor relative to a direction of gravity, and calculating, by executing instructions with processor circuitry, at least one of a first height of the table surface from the floor surface or a second height of at least a portion of a computing device on the table surface to the floor surface based on the orientation and the distance.

Example 16 includes the method defined in example 15, further including determining, by executing instructions with the processor circuitry, an angle of at least a portion of the computing device relative to the floor surface.

Example 17 includes the method as defined in example 16, wherein the calculating of the first height is based on the angle and a distance from the table surface to the computing device.

Example 18 includes the method as defined in any of examples 15 to 17, further including generating, by executing instructions with the processor circuitry, a kinematic model for determination of at least one of the first height or the second height.

Example 19 includes the method as defined in any of examples 15 to 18, further including causing an actuator to change a height of a desk having the table surface based on at least one of the first height, the second height, or biometric data associated with a user of the desk.

Example 20 includes the method as defined in any of examples 15 to 19, further including displaying, on a display, an image from an image sensor to guide an adjustment of the orientation of the distance sensor toward the floor surface.

From the foregoing, it will be appreciated that example systems, methods, apparatus, and articles of manufacture have been disclosed that enable accurate determination of a height of a desk or other table surface, such as ergonomic desks and/or tables. Examples disclosed herein can mitigate the effects of drift and other accuracies related to measuring the height. Further, examples disclosed herein can be utilized to accurately control the. Some examples disclosed herein can be utilized to effectively control the height based on biometric data associated with a user of a desk. Accordingly, examples disclosed herein can automatically adjust the desk based on accessed and/or pre-existing biometric data (e.g., based on a user identifier).

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
a distance sensor to measure a distance from a table surface to a floor surface;
an orientation sensor to measure an orientation of the distance sensor relative to a direction of gravity;
at least one memory;
instructions; and
processor circuitry to execute the instructions to calculate at least one of a first height of the table surface from the floor surface or a second height of at least a portion of a computing device on the table surface to the floor surface based on the orientation and the distance.

2. The apparatus as defined in claim 1, wherein the processor circuitry is to execute the instructions to determine an angle of at least a portion of the computing device relative to the floor surface.

3. The apparatus as defined in claim 2, wherein the processor circuitry is to execute the instructions to calculate the first height based on the angle and a distance from the table surface to the computing device.

4. The apparatus as defined in claim 1, wherein the processor circuitry is to execute the instructions to generate a kinematic model to calculate the at least one of the first height or the second height.

5. The apparatus as defined in claim 1, further including:
an actuator to change a height of a desk having the table surface; and
a controller to direct movement of the actuator based on at least one of the first height, the second height, or biometric data.

6. The apparatus as defined in claim 5, wherein the controller is unitary with the computing device.

7. The apparatus as defined in claim 1, further including an image sensor operatively coupled to the distance sensor, the image sensor for guiding an adjustment of the orientation of the distance sensor toward the floor surface.

8. The apparatus as defined in claim 1, wherein the distance sensor is a light detection and ranging (LiDAR) sensor and the orientation sensor is an inertial measurement unit (IMU) sensor.

9. A non-transitory computer readable medium comprising instructions, which when executed, cause processor circuitry to:
determine a distance from a table surface to a floor surface based on information from a distance sensor;
determine an orientation of the distance sensor relative to a direction of gravity based on information from an orientation sensor; and
calculate at least one of a first height of the table surface from the floor surface or a second height of at least a portion of a computing device on the table surface to the floor surface based on the orientation and the distance.

10. The non-transitory computer readable medium as defined in claim 9, wherein the instructions cause the processor circuitry to determine an angle of at least a portion of the computing device relative to the floor surface.

11. The non-transitory computer readable medium as defined in claim 10, wherein the instructions cause the processor circuitry to calculate the first height based on the angle and a distance from the table surface to the computing device.

12. The non-transitory computer readable medium as defined in claim 9, wherein the instructions cause the processor circuitry to execute the instructions to generate a kinematic model to calculate the at least one of the first height or the second height.

13. The non-transitory computer readable medium as defined in claim 9, wherein the instructions cause the processor circuitry to cause an actuator to change a height of a desk having the table surface based on at least one of the first height, the second height, or biometric data associated with a user of the desk.

14. The non-transitory computer readable medium as defined in claim 9, wherein the instructions cause the processor circuitry to cause an image from an image sensor to be displayed on a display to guide an adjustment of the orientation of the distance sensor toward the floor surface.

15. A method comprising:
determining, via a distance sensor, a distance from a table surface to a floor surface;
determining, via an orientation sensor, an orientation of the distance sensor relative to a direction of gravity; and
calculating, by executing instructions with processor circuitry, at least one of a first height of the table surface from the floor surface or a second height of at least a portion of a computing device on the table surface to the floor surface based on the orientation and the distance.

16. The method defined in claim 15, further including determining, by executing instructions with the processor circuitry, an angle of at least a portion of the computing device relative to the floor surface.

17. The method as defined in claim 16, wherein the calculating of the first height is based on the angle and a distance from the table surface to the computing device.

18. The method as defined in claim 15, further including generating, by executing instructions with the processor circuitry, a kinematic model for determination of at least one of the first height or the second height.

19. The method as defined in claim 15, further including causing an actuator to change a height of a desk having the table surface based on at least one of the first height, the second height, or biometric data associated with a user of the desk.

20. The method as defined in claim 15, further including displaying, on a display, an image from an image sensor to guide an adjustment of the orientation of the distance sensor toward the floor surface.
